(19) United States
(12) Patent Application Publication
(10) Pub. No.: US 2010/0169637 A1
(43) Pub. Date: Jul. 1, 2010

(54) PALETTE FOR REAL-TIME DISPLAY OF PREVIOUSLY ACCESSED DOCUMENTS

(75) Inventors: James C. Bulfani, JR., Honolulu, HI (US); Eric Chatonet, Paris (FR); Claudie Marie-Ange Camus, Paris (FR)

Correspondence Address: CONLEY ROSE, P.C.;David A. Rose, P. O. BOX 3267, HOUSTON, TX, 77253-3267, US

(73) Assignee: VISISOFT, LLC, Houston, TX (US)

(21) Appl. No.: 12/492,823

(22) Filed: Jun. 26, 2009

Related U.S. Application Data
(60) Provisional application No. 61/076,624, filed on Jun. 28, 2008.

(51) Int. Cl. G06F 3/01; H04L 9/00

(52) U.S. Cl. 713/150; 715/760; 715/790; 715/769; 715/835

(57) ABSTRACT

Palette for real-time display of previously accessed documents. At some of the illustrative embodiments are methods comprising rendering on a display a palette proximate to a window of a Web-Browser, the rendering by executing a software application by a processor, enabling a first mode of the palette, obtaining information pertaining to each of a series of Webpages previously accessed by the Web-Browser; and displaying within the palette at least some of the information pertaining to the Webpages and a reduced resolution image of one of the Webpages previously accessed.

### BACKGROUND

Web-browsers (“browsers”) are software applications that enable users to access content on the World Wide Web (“Web”) via the Internet. Users often encounter various practical difficulties while browsing the Web (e.g., organizing favorite Web pages; recalling which Web pages were relevant to the user's search and which were not; recalling which pages the user visited at all). Browsers provide access to Internet content but fail to adequately address these types of practical difficulties.

### BRIEF DESCRIPTION OF THE DRAWINGS

For a more detailed description of the various embodiments, reference will now be made to the accompanying drawings, wherein:

FIG. 1 shows an illustrative computer system in accordance with at least some of the embodiments;

FIG. 2 shows an illustrative palette rendered with a Web-browser in accordance with at least some of the embodiments;

FIG. 3 shows a drop-down menu associated with the palette in accordance with at least some of the embodiments;

FIG. 4 shows an illustrative palette in accordance with at least some of the embodiments;

FIG. 5 shows a method in accordance with at least some of the embodiments;

FIG. 6 shows a system in accordance with at least some of the embodiments;

FIG. 7A shows a method in accordance with at least some of the embodiments; and

FIG. 7B shows a method in accordance with at least some of the embodiments;

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct electrical or wireless connection, or through an indirect electrical or wireless connection via other devices and connections.

“Palette” shall mean a window that does not have customary window controls (Le., minimize, maximize and close buttons), may be of irregular (non-rectangular) shape, and can be transparent, thus exposing only the control functionality.

“Image of a Webpage” shall mean an image of the Webpage in any image format (e.g., JPEG, Bitmap, TIFF), in which the embedded links and/or streaming audio/video are inoperable.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

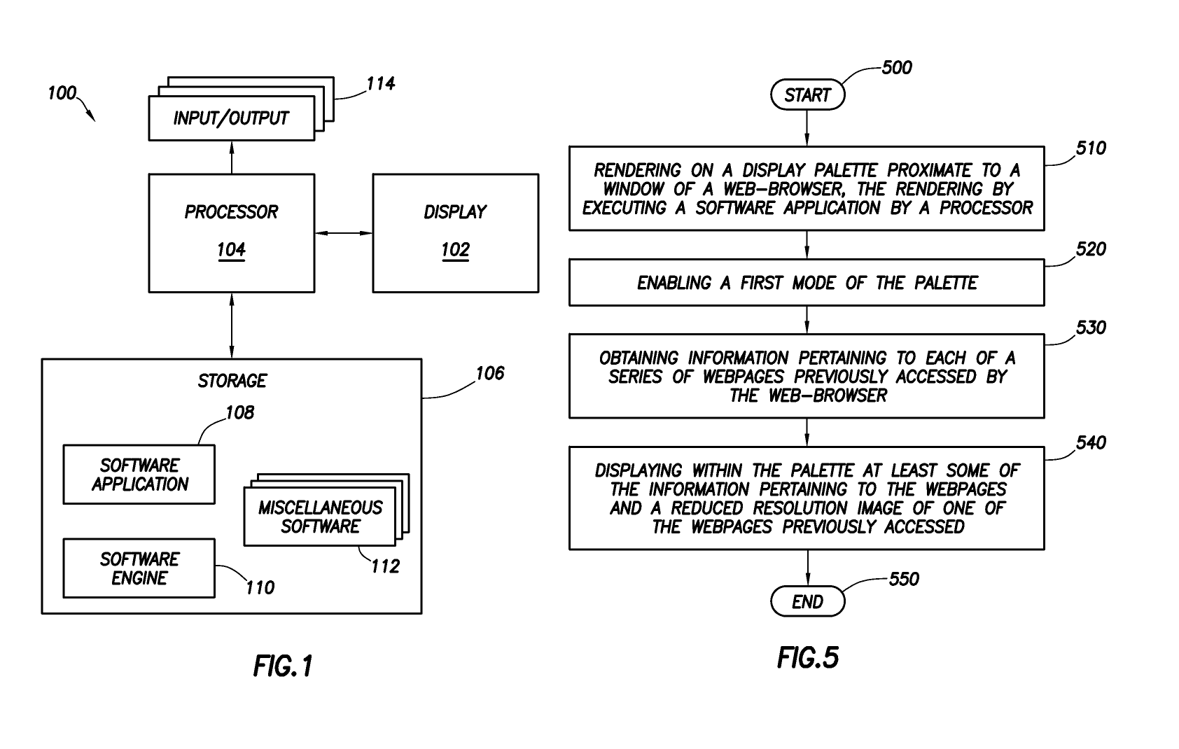

FIG. 1 shows a computer system 100 in accordance with at least some of the embodiments. In particular, the computer system 100 comprises a processor 104 (e.g., a microprocessor), and the processor 104 couples to a display 102, a storage or a memory 106 (e.g., random access memory (RAM), a hard drive), and input/output devices 114 (e.g., keyboard, mouse, microphone, optical sensors, printers, scanners, etc.). Programs executable by the processor 104 may be stored on the storage 106, and accessed when needed by the processor 104. Thus, the storage 106 is considered a computer-readable storage medium. The storage 106 stores a software application 108, a software engine 110 and miscellaneous software 112. In some embodiments, the computer system 100 may be any suitable type of system, such as desktop personal computer (PC) or a notebook computer.

When executed by the processor 104, the software application 108, in concert with the software engine 110 (or, in some embodiments, independent of the software engine 110), implements the various embodiments of the present specification. When the software application 108 is described herein as causing the processor 104 to perform an action, it should be understood that the software application 108 may be executed in tandem with the software engine 110. Further, the software application 108 performs at least some of the techniques described herein automatically (Le., without undue human intervention). The miscellaneous software 112 may comprise software such as web-browser software, word processing software, or spreadsheet software.

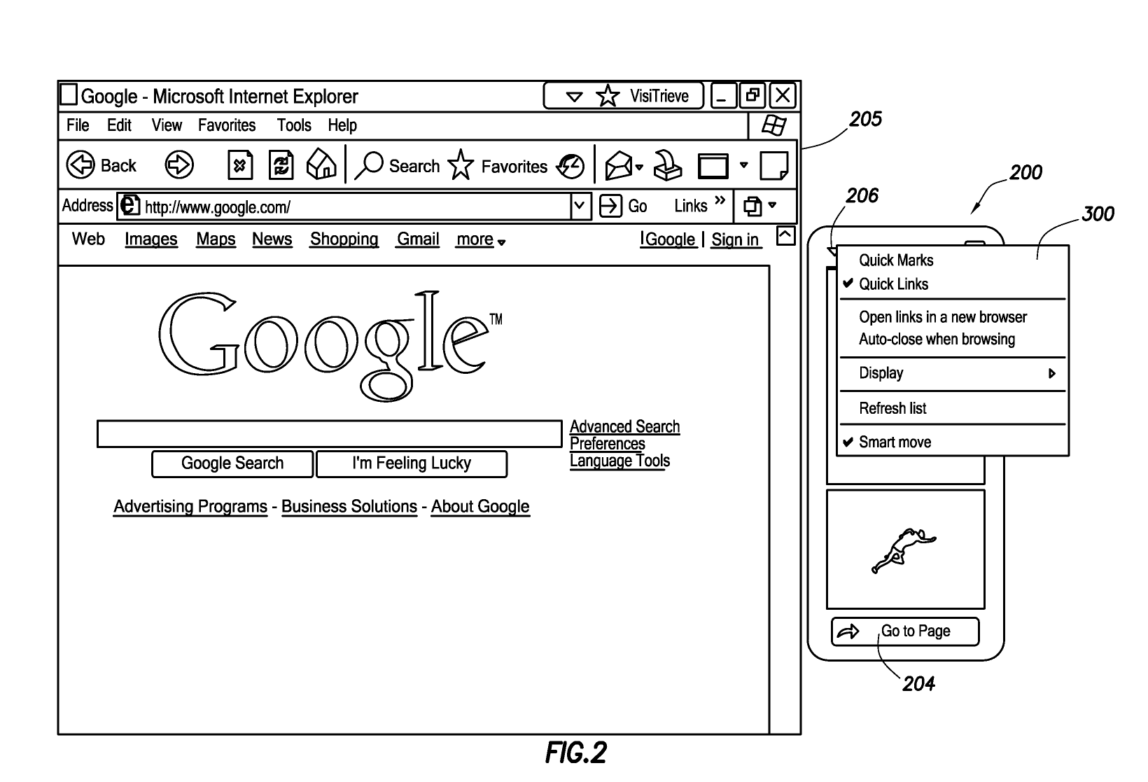

In at least some of the embodiments, the processor 104 accesses the storage 106 when needed to execute the miscellaneous software 112. Consider for the purpose of explanation, the miscellaneous software 112 is Web-browser software. The processor 104 executes miscellaneous software 112 to render a window of the Web-browser on the display 102. For example, FIG. 2 shows a window 205 of a Web-browser (e.g., Internet Explorer®) rendered by the processor 104. Although, the exemplary embodiments are explained in the context of Web-browser, it should be noted that the miscellaneous software 112 may be any software 112 executable on a computer (e.g., word processing software, or spreadsheet software).

In some embodiments the processor 104 accesses the storage 106 to execute the software application 108. The software application 108, when executed by the processor 104, causes the processor 104 to render a palette 200 proximate to the window 205 of the Web-browser. In a particular embodiment, the palette 200 and the window 205 of the Web-browser do not overlap. In other embodiments, the palette 200 is rendered within the window 205 of the Web-browser. In some embodiments, when the palette 200 is rendered by the processor 104, the processor 104 also renders an icon 206. The icon 206, when selected, causes the processor 104 to render a drop-down menu 300. The drop-down menu 300 provides a user with options associated with the palette 200. For example, the drop-down menu 300 provides the user an option to select a mode in which the palette 200 operates. More particularly, in a particular embodiment the drop-down menu 300 provides an option to select a “Quick Links” mode or a “Quick Marks” mode. Additionally, the drop-down menu 300 provides the user with options such as “Open links in a new browser” or “Smart move”. The “Open links in a new window” option, when selected, causes the processor 104 to render a new window of the Web-browser when the icon 204 is selected by a user. The “Smart move”, when selected, causes the processor 104 to retain the location of the palette 200 proximate to the window 205 of the Web-browser when window of the Web-browser is moved to a different location on the display 102. Stated otherwise, the palette 200 automatically moves with the window 205 of the Web-browser. In other embodiments, when the window 205 of the Web-browser is moved to a new location on the display 102, a user selects the palette 200 and moves palette 200 to a location proximate to the location of the window 205. The drop-down menu 300 may also provide an option that causes the processor 104 not to render the palette when Webpages are accessed by way of the Web-browser, and an option that causes the processor 104 to refresh a list of Webpages in the palette 200.

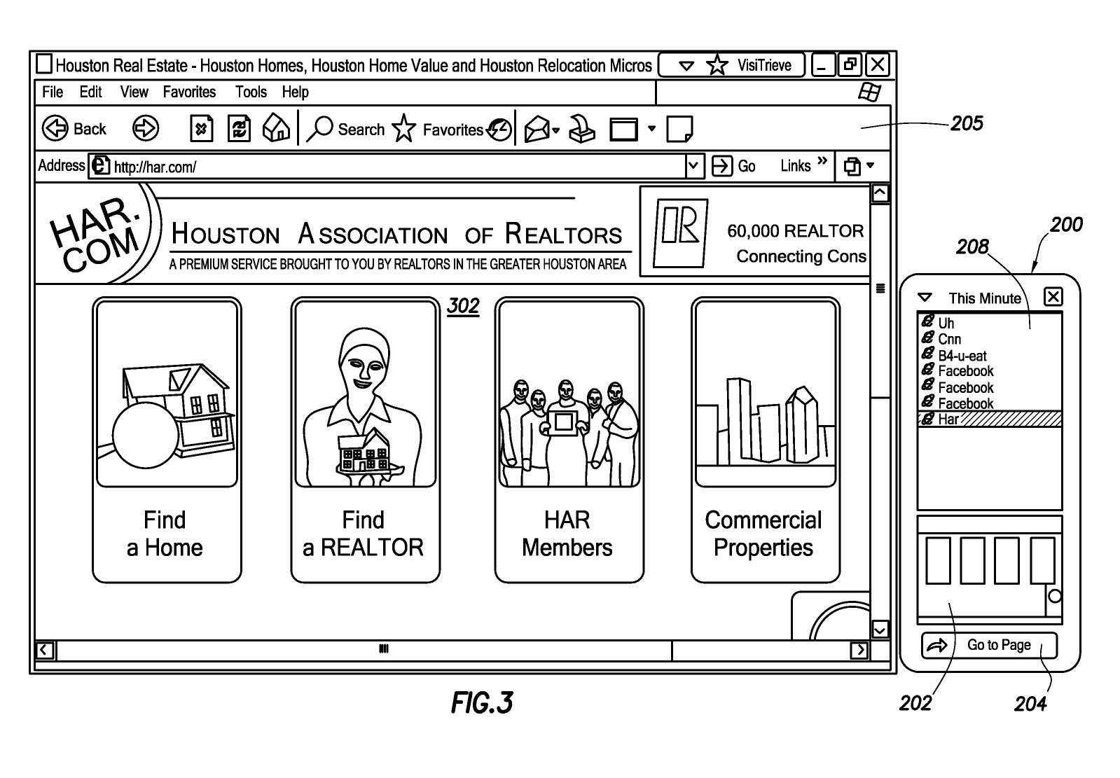

FIG. 3 shows the palette 200 operating in the “Quick Links” mode in accordance with at least some of the embodiments. In particular, when the “Quick Links” mode is enabled (i.e., the “Quick Marks” mode is disabled) the palette 200 is configured to identify each Webpage 302 accessed by a Web-browser during a predetermined period of time (e.g., during a session, or during a particular day). In some embodiments, when the palette 200 is configured to identify each Webpage 302 accessed by the Web-browser, the software application 108 causes the processor 104 to obtain information pertaining to the Webpage 302 accessed by the Web-browser and store the information pertaining to the Webpage 302 in the storage 106. The information pertaining to the Webpage 302 may include information such as a Uniform Resource Locator (URL) associated with the Webpage, an image of the Webpage, keywords associated with the Webpage (e.g., obtained from underlying source code). In a particular embodiment, when the processor 104 obtains an image of the Webpage, the processor 104 is configured to capture a “picture” of the Webpage 302, and store the image of the Webpage in any suitable image format (e.g., JPEG, Bitmap, TIFF). The embedded links and/or streaming audio/video within the Webpage 302 are inoperable in the image of the Webpage. In some embodiments, the software application 108 causes the processor 104 to obtain keywords associated with Webpage 302 based on a calculation of parameters, such as the frequency of the keywords in the webpage 302, formatting of the keywords in the Webpage 302, and position of the keywords within the webpage 302. The information pertaining to the Webpage 302 also includes time the Webpage 302 was accessed by the Web-browser. In some embodiments, the information pertaining to the Webpage 302 is obtained without prompting the user to enter the information pertaining to the Webpage 302. The information pertaining to the Webpage 302 is also obtained without any trigger to obtain the information. More particularly, the information pertaining to the Webpage 302 is obtained as the Webpage 302 is accessed by the Web-browser, but without the user having to trigger the processor 104 to obtain the information.

In some embodiments, at least some of the information pertaining to the Webpage 302 is displayed within the palette 200. In a particular embodiment, when the processor 104 renders the palette 200, the processor 104 also renders a sub-window 208 and a sub-window 202 within the palette 200. The sub-window 208 displays a list of Webpages previously accessed by the Web-browser over a selected period of time. For example, in the embodiments of FIG. 3, the sub-window 208 displays the list of the Webpages accessed by the Web-browser “This minute”. In other embodiments, the sub-window 208 displays the list of Webpages accessed by the Web-browser in any previous period of time, for example the sub-window 208 displays the Webpages accessed in previous 45 minutes.

The sub-window 202 displays a reduced resolution image of the Webpage selected from list of Webpages displayed in the sub-window 208. In some embodiments, the reduced resolution image of the Webpage is a lower resolution image of the image of the Webpage obtained by the processor 104 and stored in the storage 106. For example, in the embodiments of FIG. 3, the sub-window 202 displays a reduced resolution image of the “HAR” Webpage selected in the list of Webpages in sub-window 208. In some embodiments, the reduced resolution image in sub-window 202 corresponds with the Webpage displayed in the window 205. In other embodiments, the reduced resolution image in sub-window 202 may be associated with any of the Webpages selected from the list displayed in the sub-window 208 but not corresponding to the Webpage displayed in the window 205. In some embodiments, when the reduced resolution image displayed in sub-window 202 is selected, the software application 108 causes the processor 104 to render on the display 102 a higher resolution image of the reduced resolution image. Unlike accessing a Webpage by the Web-browser which involves access to the Internet, the processor 104 renders the higher resolution image based on the image of the Webpage stored in the storage 106 The higher resolution image is render in any suitable image format (e.g., JPEG, Bitmap, TIFF), and the embedded links and/or streaming audio/video within the higher resolution image are inoperable.

The palette 200 also comprises an icon 204 that, when selected, causes the processor 104 to access by the Web-browser the Webpage selected in the list of Webpages displayed in the sub-window 208. In particular, when the icon 204 is selected the Webpage selected in the list of Webpages in sub-window 208 is accessed by the Web-browser by way of the Internet. The accessed Webpage is displayed in a window 205 of the Web-browser rendered by the processor 104. If “Open link in a new window” option is selected (Le., drop-down menu 300 in FIG. 2) a new window of the Web-browser is rendered by the processor 104, and Webpage accessed is displayed in the new window.

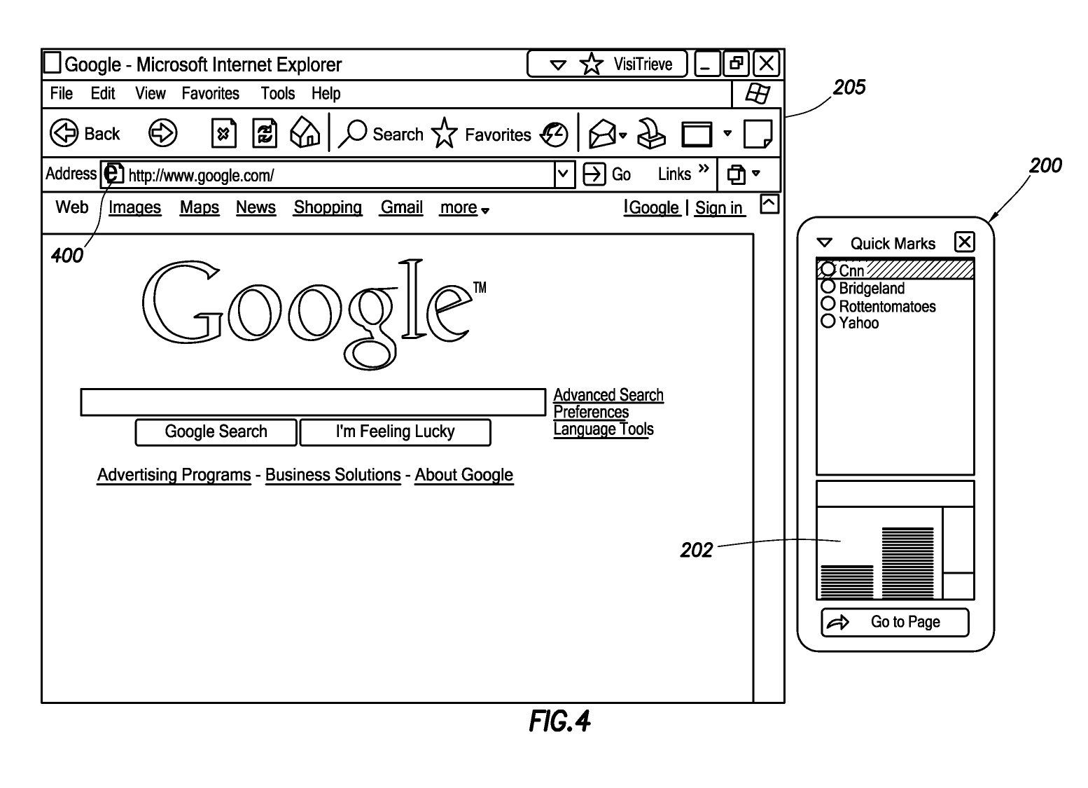

FIG. 4 shows the palette 200 operating in the “Quick Marks” mode in accordance with at least some of the embodiments. In particular, when the “Quick Marks” mode is enabled (i.e., the “Quick Links” mode is disabled) the palette 200 is configured to enable a user to select an icon within the window 205 of the Web-browser and drag the icon to the palette 200. In some embodiments, the icon is associated with the Webpage currently accessed by the Web-browser. For example, in the embodiments of FIG. 4, the user selects icon 400 associated with the Webpage (e.g., within the Uniform Resource Locator (URL) bar of the window) the window 205 of the Web-browser, and drags the icon 400 to the palette 200. In response to the selecting and the dragging of the icon 400, the software application 108 causes the processor 104 to obtain information pertaining to the Webpage associated with the icon 400 and store the information in the storage 106. The information pertaining to the Webpage associated with the icon 400 may include information such as a Uniform Resource Locator (URL) associated with the Webpage, an image of the Webpage, a keyword or titleword associated with the Webpage (e.g., obtained from underlying source code).

In response to the selecting and the dragging of the icon 400, the software application 108 also causes the processor 104 to display within the palette 200 at least some of the information pertaining to the Webpage associated with the icon 400. Consider for the purpose of explanation, that a Webpage www.cnn.com is accessed by the Web-browser. A user selects an icon associated with the Webpage (i.e., www.cnn.com in the URL bar of the window) and drags the icon to the palette 200, then the sub-window 208 within the palette 200 displays “CNN” in the list of Webpages and the sub-window 202 within the palette 200 displays a reduced resolution image of the Webpage. The reduced resolution image of the Webpage is a lower resolution image of the image of the Webpage obtained by the processor 104 in response to the selecting and the dragging of the icon 400.

In alternative embodiments, a palette may be configured to display advertisements. In particular, when the software application 108 causes the processor 104 to render a palette that displays advertisements instead of information pertaining to a Webpage accessed by a Web-browser. The advertisements are related to the software 112 with which the palette is associated. In some embodiments, the palette is rendered to display the advertisements related to the software 112 (e.g., a Web-browser) when the software 112 is the “active” or “top-most” software being executed by the processor 104. However, if the software 112 (Le., the Web-browser) is no longer the “active” or “top-most” software, the palette disappears until the software 112 (i.e., the Web-browser) is once again the active software executed by the processor 104. In other embodiments, if the software 112 (Le., the Web-browser) is no longer the “active” or “top-most” software, the software application 108 will cause the processor 104 to display within the palette advertisement related to the current “active” or “top-most” software 112 (e.g., Word-processor). In some embodiments, the advertisements are previously stored on the storage 106. In other embodiments, advertisements are supplied to the computer system 100 via the Internet (e.g., from an advertising firm).

FIG. 5 shows a method in accordance with at least some of the embodiments. In particular, the method starts (block 500) and a palette is rendered proximate to a window of a Web-browser (block 510). In some embodiments, the palette is rendered by a processor executing a software application. Next, a first mode of the palette is enabled (block 520). Thereafter, information pertaining to each of a series of Webpages previously accessed by the Web-browser is obtained (block 530). Lastly, at least some of the information pertaining to the Webpages and a reduced resolution image of one of the Webpages is displayed within the palette (block 540), and the method ends (block 550).

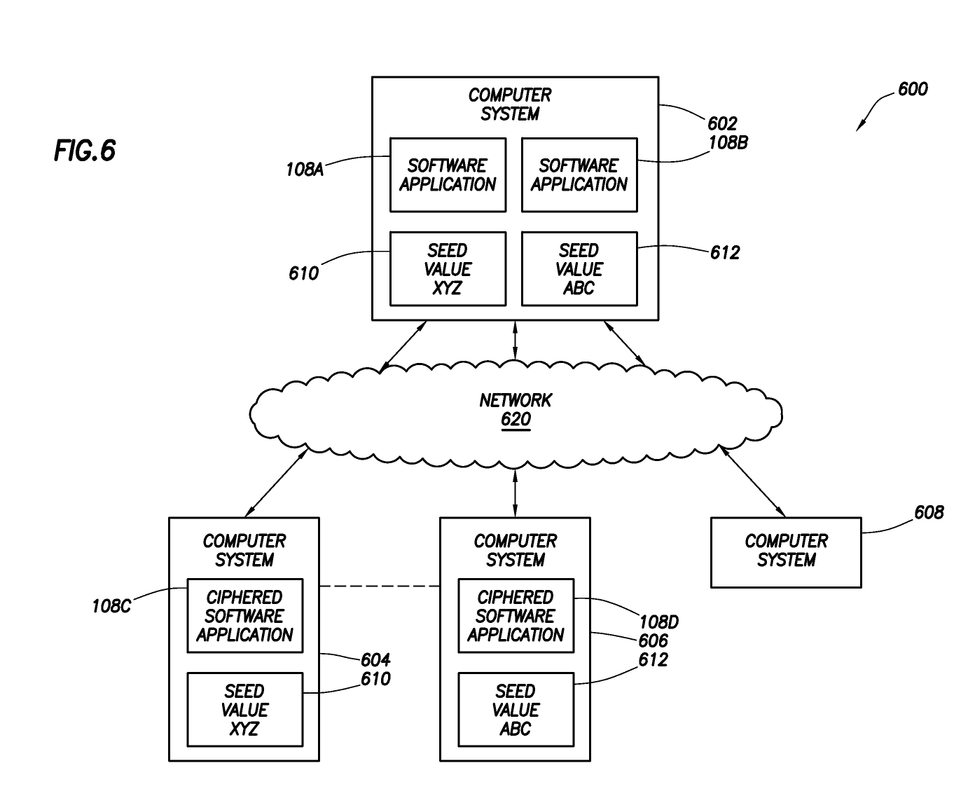

In some embodiments, to mitigate software piracy of the software application 108 (possibly with the software engine 110), each copy of the software application is ciphered with a seed value that is exclusive for the copy of the software application. FIG. 6 shows a system 600 to mitigate software piracy in accordance with at least some embodiments. In particular, system 600 comprises a plurality of computer systems 602-608 that are similar to the computer system 100 of the embodiments of FIG. 1. The computer systems 602-608 are coupled with each other by way of a network 620 (e.g. wired or wireless). In a particular embodiment, computer system 602 is configured to cipher a copy of the software application 108 with a seed value that is exclusive for the copy of the software application 108, and as needed, transmit the ciphered copy of the software application 108 and the seed value to one of the computer systems 604-608. The computer system 602 may use any seed value based encryption or hash algorithm, such as Secure Socket Layer (SSL) encryption. The seed value used by the computer system 602 to cipher is exclusive for a copy of the software application 108. Thus, when the ciphered copy of the software application 108 and the seed value are received by one of the computer systems 604-608, the seed value is used to decipher only the ciphered copy of the software application 108. Although, the exemplary embodiments are explained in the context of software application 108, it should be noted that the any software application may be equivalently be used.

Consider for the purpose of explanation, the computer system 602 ciphers a first copy of the software application 108A with a first seed value XYZ 610 that is exclusive for the first copy of the software application 108A, and ciphers a second copy of the software application 108B with a second seed value ABC 612 that is exclusive for the second copy of the software application 108B. When needed, the computer system 604 and the computer system 606 access the computer system 602 to receive the first ciphered copy of the software application 108C and the first seed value XYZ 610, and the second ciphered copy of the software application 108D and the second seed value ABC 612, respectively. Thereafter, the computer system 604 is configured to decipher the first ciphered copy of the software application 108C based on the first seed value XYZ 610, and the computer system 606 is configured to decipher the second ciphered copy of the software application 108D based on the second seed value ABC 612. However, in the exemplary embodiments, the first ciphered copy of the software application 108C cannot be deciphered based on the second seed value ABC 612, and vice versa, the second ciphered copy of the software application 108D cannot be deciphered based on the first seed value XYZ 610.

The exemplary embodiments are configured to reduce the occurrence of malicious entities (e.g., hackers) using unauthorized copies of software application 108. Even if hypothetically a malicious entity is able acquire a ciphered copy of the software application 108 and the corresponding seed value, the malicious entity will be able to decipher only the particular ciphered copy of the software application 108 because the seed value is exclusive for only the particular ciphered copy of the software application 108. Thus, while the malicious entity is able to acquire other ciphered copies of software application 108, the malicious entity is still not able to decipher the other ciphered copies of the software application 108 based on the seed value.

The computer system 602 is also configured to cipher updates to the software application with the seed value that is exclusive for the software application. Stated otherwise, the seed value used to cipher the updates to the software application is the same as the seed value used to cipher the software application. When needed one of the computer system 604-608 accesses the computer system 602 to receive the ciphered update to the software application and the seed value. The one of the computer system 604-608 deciphers the ciphered update based on the seed value and apply the update to the software application.

Continuing with the previous example, the computer system 602 ciphers the update to the first copy of the software application with the first seed value XYZ 610, and ciphers the updated to the second copy of the software application with the second seed value ABC 612. Thereafter, the computer system 604 deciphers the ciphered update to the first copy of the software application based on the first seed value XYZ 610, and applies the update to the first copy of the software application. The computer system 606 deciphers the ciphered update to the second copy of the software application based on the second seed value ABC 612, and applies the update to the second copy of the software application.

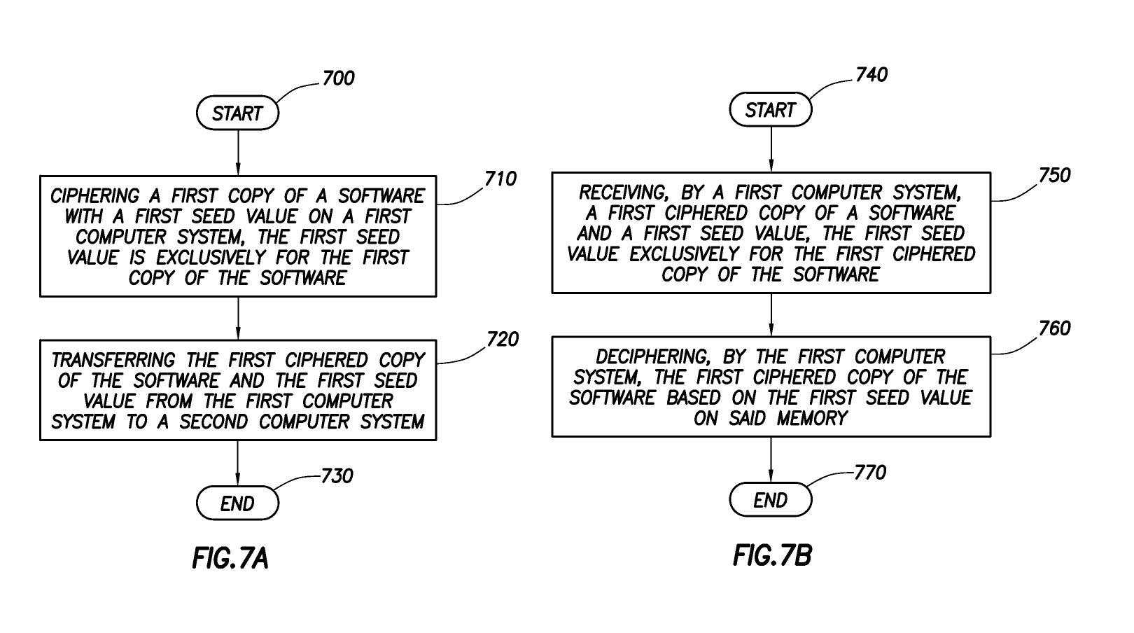

FIG. 7A shows a method in accordance with at least some of the embodiments. In particular, the method starts (block 700), and a first copy of a software is ciphered with a first seed value that is exclusively for the first copy of the software (block 710). Thereafter, the first ciphered copy of the software and the first seed value are transferred (block 720) and the method ends (block 730). FIG. 7B shows a method in accordance with at least some of the embodiments. In particular, the method begins (block 740) and a first ciphered copy of a software and a first seed value that is exclusively for the first ciphered copy of the software is received (block 750). Thereafter, the first ciphered copy of the software is deciphered based on the first seed value (block 760) and the method ends (block 770).

From the description provided herein, those skilled in the art are readily able to combine software created as described with appropriate computer hardware to create a special purpose computer system and/or special purpose computer sub-components in accordance with the various embodiments, to create a special purpose computer system and/or computer sub-components for carrying out the methods of the various embodiments and/or to create a computer-readable media that stores a software program to implement the method aspects of the various embodiments.

While the various embodiments of the present invention have been shown and described, modifications thereof can be made by one skilled in the art without departing from the spirit and teachings of the invention. For example, while the various embodiments are related to a Windows® operating systems utilizing Internet Explorer®, the palette 300 are equally applicable and functional with any operating system (e.g., Macintosh OSX, Unix, Linux). In particular, the software application 108 described herein is cross-browser (i.e., compatible with any browser), cross-platform (i.e., compatible with PC, Mac, UNIX and Linux), cross-lingual (i.e., operable in languages, such as English, French, German, Italian, Portuguese and Spanish), cross-format, cross-machine (i.e., can be executed on separate computer systems integrated into a central location); cross-application (i.e., palette may be rendered within software); and most importantly can integrate the use and data across all of these. The scope of protection is not limited by the description set out above. Each and every claim is incorporated into the specification as an embodiment of the present invention.

We claim:

1. A system, comprising:
a processor;
a memory coupled to the processor;
the memory stores a program that, when executed by the processor, causes the processor to:
render a palette on a display proximate to a window of a Web-browser;
enable a first mode of the palette;
identify each of a series of Webpages previously accessed by the Web-browser;
obtain information pertaining to the previously accessed Webpages; and
store the information pertaining to the Webpages along with an image of each of the Webpages on a storage device.

2. The system of claim 1 wherein the palette does not overlap the window of the Web-browser.

3. The system of claim 1 wherein when the processor renders the palette, the program further causes the processor to:
render a first sub-window that displays a list of the Webpages previously accessed by the Web-browser, wherein the list comprises Webpages accessed within a time frame; and
render a second sub-window that displays a reduced resolution image that corresponds with a Webpage selected from the list displayed in the first sub-window.

4. The system of claim 3 wherein when the processor renders the palette, the program further causes the processor to display, at the behest of a user, a higher resolution image of the reduced resolution image displayed in the second sub-window.

5. The system of claim 1 wherein when the processor renders the palette, the program further causes the processor to:
disable the first mode of the palette;
enable a second mode of the palette;
select, at the behest of a user, an icon associated with the Webpage displayed within the window of the Web-Browser; and
drag, at the behest of the user, the icon to the palette.

6. The system of claim 5 wherein when the processor drags the icon, the program further causes the processor to:
obtain information pertaining to the Webpage; and
display the information pertaining to the Webpage and a reduced resolution image of the Webpage within the palette.

7. A method comprising:
rendering on a display a palette proximate to a window of a Web-Browser, the rendering by executing a software application by a processor;
enabling a first mode of the palette;
obtaining information pertaining to each of a series of Webpages previously accessed by the Web-Browser; and
displaying within the palette at least some of the information pertaining to the Webpages and a reduced resolution image of one of the Webpages previously accessed.

8. The method of claim 7 wherein the rendering further comprising rendering the palette such that the palette does not overlap the window of the Web-Browser.

9. The method of claim 7 wherein the displaying further comprising:
displaying in a first sub-window within the palette the at least some of the information pertaining to Webpages; and
displaying in a second sub-window within the palette the reduced resolution image of the one of the Webpages.

10. The method of claim 9 further comprising:
rendering on the display a higher resolution image of the reduced resolution image displayed in the second sub-window, the rendering responsive to selection of reduced resolution image displayed within the palette.

11. The method of claim 7 further comprising:
disabling the first mode of the palette;
enabling a second mode of the palette;
obtaining information pertaining to a Webpage displayed within the window of the Web-browser, the obtaining responsive to selecting and dragging an icon associated with the Webpage; and
displaying within the palette at least some of the information pertaining to Webpage and a reduced resolution image of the Webpage.

12. A computer-readable storage medium storing a program that, when executed by a processor, causes the processor to:
render on a display a palette proximate to a window of a Web-Browser;
enable a first mode of the palette;
obtain information pertaining to each of a series of Webpages previously accessed by the Web-Browser; and
display within the palette at least some of the information pertaining to Webpages and a reduced resolution image of one of the Webpages previously accessed.

13. The computer-readable storage medium of claim 12 wherein when the processor renders the palette, the program further causes the processor to render the palette such that the palette does not overlap the window of the Web-Browser.

14. The computer-readable storage medium of claim 12 wherein when the processor renders the palette, the program causes the processor to:
render a first sub-window within the palette that displays at least some of the information pertaining to Webpages; and
render a second sub-window within the palette that displays the reduced resolution image of the one of the Webpages.

15. The computer-readable storage medium of claim 14 wherein when a user selects the reduced resolution image displayed within the palette, the program further causes the processor to render on the display a higher resolution image of the reduced resolution image.

16. The computer-readable storage medium of claim 12 wherein when a user selects an icon associated with the Webpage displayed within the window of the Web-browser, and drags the icon to the palette, the program causes the processor to:
obtain information pertaining to the Webpage associated with the icon; and
display within the palette at least some of the information pertaining to Webpage associated with the icon and a reduced resolution image of the Webpage associated with the icon.

17. A method, comprising:
ciphering a first copy of a software with a first seed value on a first computer system, the first seed value is exclusively for the first copy of the software; and
transferring the first ciphered copy of the software and the first seed value from the first computer system to a second computer system.

18. The method of claim 17 further comprising:
ciphering a second copy of the software with a second seed value on the first computer system, the second seed value is exclusively for the second copy of the software; and
transferring from the first computer system to a third computer system, the second ciphered copy of the software and the second seed value;
wherein the first seed value is different from the second seed value, and the first computer system is separate from the second computer system and the third computer system.

19. The method of claim 17 further comprising:
ciphering, on the first computer system, an update to the first copy of the software with the first seed value, the first seed value is exclusively for the update to the first copy of the software; and
transferring the ciphered update and the first seed value to the second computer system.

20. A method comprising:
receiving, by a first computer system, a first ciphered copy of a software and a first seed value, the first seed value exclusively for the first ciphered copy of the software; and
deciphering, by the first computer system, the first ciphered copy of the software based on the first seed value on said memory.

21. The method of claim 20 further comprising:
receiving, by the first computer system, a ciphered update to the first copy of the software and the first seed value, the first seed value exclusively for the ciphered update; and
deciphering, by the first computer system, the ciphered update based on the first seed value; and
applying the deciphered update to the first copy of the software.

22. A system comprising:
a computer system configured to cipher a first copy of a software with a first seed value, the first seed value exclusively for the first copy of the software;
the computer system is further configured to cipher a second copy of the software with a second seed value, different from the first seed value, that is exclusively for the second copy of the software; and
the computer system configured to transfer the first ciphered copy of the software and the first seed value, and the second ciphered copy of the software and the second seed value.

23. The system of claim 22 wherein the computer system is further configured to cipher an update to the first copy of the software with the first seed value, the first seed value exclusively for the update, and the computer system is configured to transfer the ciphered update with the first seed value.

24. A system comprising:
a computer system configured to receive a first ciphered copy of the software and a first seed value, the first seed value is exclusively for the first ciphered copy of the software;
the computer system further configured to decipher the first ciphered copy of the software based on the first seed value.

25. The system of claim 24
wherein the computer system is configured to receive a ciphered update to the first copy of the software and the first seed value, the first seed value exclusively for the ciphered update; and
the computer system further configured to decipher the ciphered update based on the first seed value and apply the deciphered update to the first copy of the software.

26. A computer-readable storage medium storing a program that, when executed by a processor, causes the processor to:
receive a first ciphered copy of a software and a first seed value, the first seed value exclusively for the first ciphered copy of the software; and
decipher the first ciphered copy of a software based on the first seed value.

27. The computer-readable storage medium of claim 26 wherein the program further causes the processor to:
receive an ciphered update to the first copy of the software with the first seed value, the first seed value exclusively for the ciphered update;
decipher the ciphered update to the first copy of the software based on the first seed value; and
apply the deciphered update to the first copy of the software.

28. A computer-readable storage medium storing a program that, when executed by a processor, causes the processor to:
cipher a first copy of a software with a first seed value, the first seed value exclusively for the first copy of the software; and
transfer the ciphered first copy of the software and the first seed value.

29. The computer-readable storage medium of claim 28 wherein the program further causes the processor to:
cipher a second copy of the software with a second seed value, the second seed value is exclusively for the second copy of the software; and
transfer the ciphered second copy of the software and the second seed value;
wherein the first seed value is different from the second seed value.
